(19) United States
(12) Patent Application Publication
(10) Pub. No.: US 2013/0308076 A1
(43) Pub. Date: Nov. 21, 2013

(54) FLEXIBLE DISPLAY AND METHOD FOR MANUFACTURING THE SAME

(71) Applicant: Takuto Yasumatsu, Osaka-shi (JP)

(72) Inventor: Takuto Yasumatsu, Osaka-shi (JP)

(73) Assignee: SHARP KABUSHIKI KAISHA, Osaka-shi, Osaka (JP)

(21) Appl. No.: 13/876,896

(22) PCT Filed: Sep. 26, 2011
(86) PCT No.: PCT/JP11/05390

§ 371 Date: Apr. 4, 2013

(30) Foreign Application Priority Data
Oct. 1, 2010 (JP) 2010-224060

(51) Int. Cl. H05B 33/04; H05B 33/10

(52) U.S. Cl. CPC H05B 33/04; H05B 33/10
USPC 349/84; 359/296; 313/506; 445/25

(57) ABSTRACT

A liquid crystal panel 3 includes a TFT-side film substrate 5 made of resin, a counter-side film substrate 7 made of resin, and a liquid crystal device. A TFT-side laminated film 15 is bonded to the TFT-side film substrate 5 with a TFT-side photo-curable transparent adhesive layer 17 being interposed therebetween, and a counter-side laminated film 19 is bonded to the counter-side film substrate 7 with a counter-side photo-curable transparent adhesive layer 21 being interposed therebetween. A CF 23 is formed on a surface of the counter-side laminated film 19 opposite to the counter-side film substrate 7. Thus, a flexible display can be provided, which has such high reliability that no cracking occurs in a device layer and that no peeling at a bonding surface of a flexible film substrate and an adjacent layer occurs, and which has a thickness effectively reduced even if a plurality of functional layers are formed.

### TECHNICAL FIELD

The present disclosure relates to a high-quality thin flexible display, such as a liquid crystal display, in which a plurality of functional layers can be formed, and to a method for manufacturing the flexible display.

### BACKGROUND ART

Patent Document 1 discloses a technique for manufacturing a display in such a manner that a color filter (CF) is formed on a base film to form a CF film serving as an optical functional layer and the CF film is bonded to a display panel including a transparent substrate and a light emitting device with the base film facing the transparent substrate or the CF facing the transparent substrate.

Examples of the base film include a polyethylene terephthalate (PET) film having a thickness of 100 μm, and examples of the transparent substrate of the display panel include a PET film having a thickness of 125 μm. Moreover, an ultraviolet-curable adhesive agent is used for bonding of the CF film.

### CITATION LIST

### Patent Document

PATENT DOCUMENT 1: Japanese Patent Publication No. 2009-064010 (see paragraphs 0012, 0013, 0036, and 0037 and FIGS. 1 and 2)

### SUMMARY OF THE INVENTION

### Technical Problem

Recently, particular attention has been drawn to a flexible display using a flexible film substrate made of resin because of the following reasons. The flexible display is thin, lightweight, and is less likely to be damaged. Moreover, the flexible display can be formed in a curved shape.

However, since the flexible film substrate is made of resin, the flexible film substrate has lower rigidity and is likely to be thermally deformed as compared to a glass substrate having heat resistance and having high rigidity. This is apparent from Patent Document 1 describing that the transparent substrate formed of the PET film is used and also describing, at, e.g., paragraph 0036, that the transparent substrate is expanded/contracted due to mechanical stress or heat in the process of forming electrodes etc. Moreover, Patent Document 1 describes that the CF is formed in the state in which the positions of red (R), green (G), and blue (B) are adjusted depending on contraction of the transparent substrate. However, in Patent Document 1, transparent substrate contraction itself is not taken into consideration.

In particular, in the case where a thin flexible film substrate made of resin is used as a component of a flexible display, great warpage of the flexible film substrate occurs due to, e.g., thermal deformation. If great warpage of the flexible film substrate occurs, there is a possibility that an inorganic film, such as a gate insulating film, used for a device layer (a thin film transistor (TFT) layer) is, even without cracking of the flexible film substrate, likely to be cracked, or that peeling at a bonding surface of the flexible film substrate and an adjacent layer occurs.

The present disclosure has been made in view of the foregoing, and it is an objective of the present disclosure to provide a flexible display which has such high reliability that no cracking occurs in a device layer and that no warpage of a flexible film substrate or no peeling at a bonding surface of the flexible film substrate and an adjacent layer occurs, and which has a thickness effectively reduced even if a plurality of functional layers are formed.

### Solution to the Problem

In the present disclosure, a flexible film substrate is, in order to accomplish the foregoing objective, reinforced by a laminated film and a functional layer is formed on the laminated film.

Specifically, first to ninth aspects of the present disclosure relate to a flexible display, and a tenth aspect of the present disclosure relates to a method for manufacturing the flexible display. The solution to the problem is as follows.

That is, the first aspect is intended for a flexible display which includes a display panel including a flexible film substrate made of resin and a light emitting device; and a laminated film bonded to the flexible film substrate of the display panel with a photo-curable transparent adhesive layer being interposed therebetween. One or more of an optical functional layer, a sensor functional layer, and a gas barrier functional layer is formed on a surface of the laminated film on at least one of a side close to the flexible film substrate or a side opposite to the flexible film substrate.

The second aspect is intended for the flexible display of the first aspect, in which the flexible film substrate is made of polyimide.

The third aspect is intended for the flexible display of the first aspect, in which the laminated film is made of polyethylene naphthalate, polyethylene terephthalate, polyether sulfone, polycarbonate, or cycloolefin polymer.

The fourth aspect is intended for the flexible display of the first aspect, in which the photo-curable transparent adhesive layer is made of an acrylate-based or epoxy-based photo-curable transparent adhesive agent.

The fifth aspect is intended for the flexible display of the fourth aspect, in which the photo-curable transparent adhesive layer has an elastic modulus of 100 MPa-2 GPa at a room temperature of 25° C. after curing, and has an elastic modulus of equal to or greater than 40 MPa at an environmental temperature of 60-70° C. in use.

The sixth aspect is intended for the flexible display of the first aspect, in which the optical functional layer is formed of a color filter (CF), an anti-reflection (AR) film, an anti-glare (AG) film, a retardation film, a polarizing film, or a 3-dimensional (3D) film.

The seventh aspect is intended for the flexible display of the first aspect, in which the sensor functional layer is formed of an electrostatic capacitance touch panel or a pressure-sensitive touch panel.

The eighth aspect is intended for the flexible display of the first aspect, in which the gas barrier functional layer is formed of an inorganic film made of a silicon oxide-based, silicon oxynitride-based, alumina oxide-based, or titanium oxide-based material, or a multilayer film of the inorganic film and an organic film made of a polyvinyl alcohol-based, polyvinylidene chloride-based, acrylonitrile-based, acrylic acid-based, or nylon-based material.

The ninth aspect is intended for the flexible display of the first aspect, in which the light emitting device is a liquid crystal device, an organic electro luminescence (EL) device, or an electrophoretic device.

The tenth aspect is intended for a method for manufacturing a flexible display, which includes an adhesive layer formation step of forming, for a display panel including a flexible film substrate made of resin and a light emitting device, a photo-curable transparent adhesive layer on the flexible film substrate of the display panel; a film bonding step of bonding, after the adhesive layer formation step, a laminated film to the flexible film substrate in vacuum atmosphere with the photo-curable transparent adhesive layer being interposed therebetween; a functional layer formation step of forming, before or after the film bonding step, one or more of an optical functional layer, a sensor functional layer, and a gas barrier functional layer on a surface of the laminated film on at least one of a side close to the flexible film substrate or a side opposite to the flexible film substrate; and an adhesive layer curing step of curing, in parallel with the film bonding step or after the film bonding step and the functional layer formation step, the photo-curable transparent adhesive layer by light irradiation.

### Advantages of the Invention

According to the first to tenth aspects, the flexible film substrate made of resin is reinforced by the laminated film. Thus, no warpage of the flexible film substrate due to, e.g., thermal deformation occurs, and cracking of an inorganic film, such as a gate insulating film, used for a TFT layer can be reduced or prevented. Moreover, peeling at a bonding surface of the flexible film substrate and an adjacent layer is less likely to occur. Consequently, reliability can be enhanced.

The laminated film is bonded to the flexible film substrate with the photo-curable transparent adhesive layer being interposed therebetween. Thus, warpage reduction or prevention and reliability upon bending can be ensured by material properties of a photo-curable transparent adhesive agent.

One or more functional layers are formed on at least one of the surfaces of the laminated film. Thus, a flexible liquid crystal display, organic EL display, or electrophoretic display having a thickness effectively reduced even if a plurality of functional layers are formed.

In particular, according to the fifth aspect, the photo-curable transparent adhesive layer has the elastic modulus of 100 MPa-2 GPa at the room temperature of 25° C. after curing, and has the elastic modulus of equal to or greater than 40 MPa at the environmental temperature of 60-70° C. in use. Thus, warpage of the flexible film substrate can be effectively reduced, and reliability of the flexible film substrate upon bending can be improved.

According to the tenth aspect, the laminated film is bonded to the flexible film substrate in vacuum atmosphere. Even if the laminated film and the flexible film substrate are different in material from each other, it can be ensured that the laminated film is bonded to the flexible film substrate.

### BRIEF DESCRIPTION OF THE DRAWINGS

FIG. 1 is a cross-sectional view of a liquid crystal display as a flexible display of a first embodiment.

FIGS. 2(a)-2(i) are cross-sectional views illustrating steps of manufacturing the liquid crystal display as the flexible display of the first embodiment.

FIG. 3 is a cross-sectional view of a liquid crystal display as a flexible display of a second embodiment.

FIG. 4 is a cross-sectional view of a liquid crystal display as a flexible display of a third embodiment.

FIG. 5 is a cross-sectional view of a liquid crystal display as a flexible display of a fourth embodiment.

FIG. 6 is a cross-sectional view of a liquid crystal display as a flexible display of a fifth embodiment.

FIG. 7 is a cross-sectional view of a liquid crystal display as a flexible display of a sixth embodiment.

FIG. 8 is a cross-sectional view of a liquid crystal display as a flexible display of a seventh embodiment.

FIG. 9 is a cross-sectional view of a liquid crystal display as a flexible display of an eighth embodiment.

### DESCRIPTION OF EMBODIMENTS

Embodiments of the present disclosure will be described below with reference to drawings.

### First Embodiment

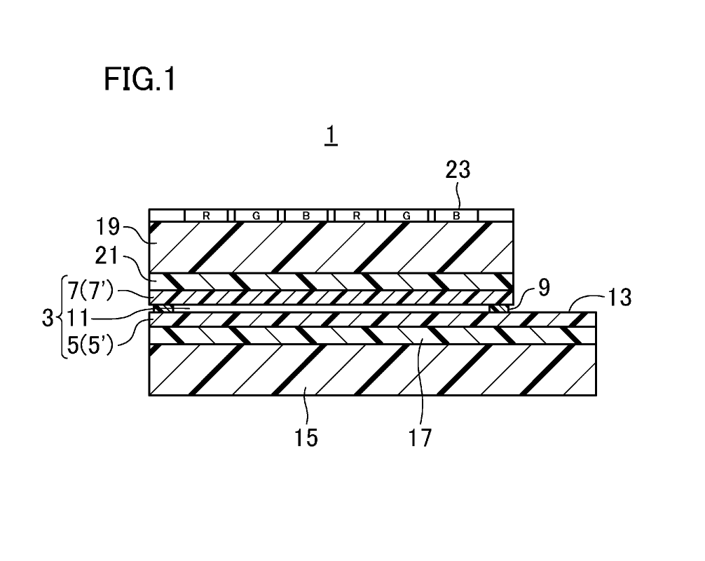

FIG. 1 illustrates a flexible display of a first embodiment. In the present embodiment, a liquid crystal display 1 in which a light emitting device is a liquid crystal device will be described. In FIG. 1, a reference numeral “3” represents an active matrix driven liquid crystal panel serving as a display panel. The liquid crystal display 1 is formed by mounting a backlight (not shown in the figure) on the liquid crystal panel 3.

The liquid crystal panel 3 includes a flexible film substrate 5 made of resin and arranged on a lower side as viewed in FIG. 1, and a flexible film substrate 7 made of resin and arranged on an upper side as viewed in FIG. 1 so as to face the flexible film substrate 5. Both of the flexible resin film substrates 5, 7 are preferably made of polyimide, and the thickness of each of the flexible resin film substrates 5, 7 is preferably set at less than 50 μm considering that sufficient flexibility of the liquid crystal display 1 which is a finished product is realized.

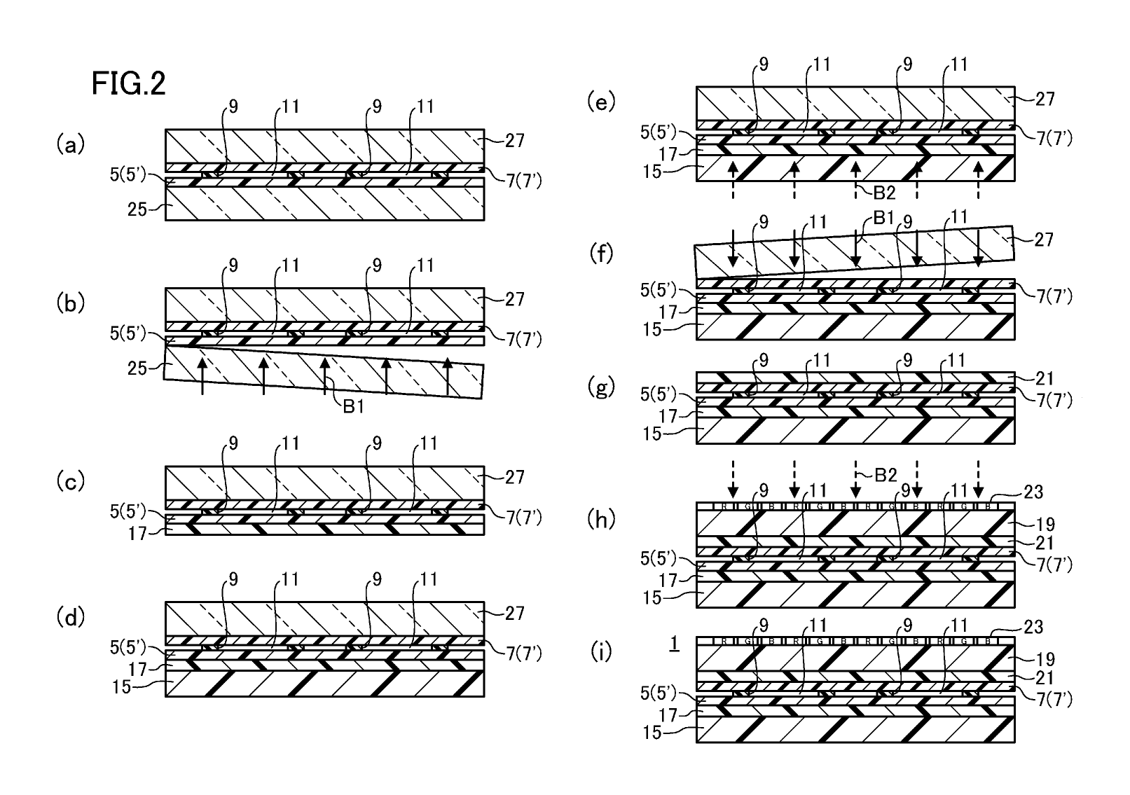

A TFT substrate (active matrix substrate) in which a pixel electrode and a TFT connected to the pixel electrode are formed in each of a plurality of pixels arranged in a matrix is provided at an upper surface of the flexible film substrate 5 arranged on the lower side as viewed in FIG. 1. However, for the sake of illustration, only the flexible film substrate 5 is illustrated in FIGS. 1 and 2(a)-2(i) which are views illustrating manufacturing steps which will be described later. The flexible film substrate 5 is hereinafter referred to as a “TFT-side film substrate 5.” However, for the sake of description, the TFT-side film substrate 5 is sometimes referred to as a “TFT substrate.” In such a case, a reference numeral “5”' is used to represent the TFT substrate.

On the other hand, a counter substrate in which a common electrode is formed is provided at a lower surface of the flexible film substrate 7 arranged on the upper side as viewed in FIG. 1. However, for the sake of illustration, the common electrode is not illustrated. As in the TFT-side film substrate 5, only the flexible film substrate 7 is illustrated in FIGS. 1 and 2(a)-2(i) which are the views illustrating the manufacturing steps which will be described later. Moreover, no CF is formed on the flexible film substrate 7. The flexible film substrate 7 is hereinafter referred to as a “counter-side film substrate 7.” However, for the sake of description, the counter-side film substrate 7 is sometimes referred to as a “counter substrate.” In such a case, a reference numeral “7” is used to represent the counter substrate.

Although an alignment film is formed on each of surfaces of the TFT substrate 5′ and the counter substrate 7′ facing each other, such an alignment film is not illustrated for the sake of illustration. Only the TFT-side film substrate 5 (TFT substrate 5′) and the counter-side film substrate 7 (counter substrate 7′) are simply illustrated, and the same applies to other embodiments which will be described later.

A sealing material 9 made of, e.g., ultraviolet-curable epoxy-based resin is, between peripheral edge parts of the TFT substrate 5′ and the counter substrate 7′, applied in a frame shape so as to extend across the entire periphery. The TFT substrate 5′ and the counter substrate 7′ are bonded together by the sealing material 9. A liquid crystal layer 11 having, e.g., nematic liquid crystal molecules with electrooptical properties is sealed in an internal space surrounded by the TFT substrate 5′, the counter substrate 7′, and the sealing material 9.

The TFT-side film substrate 5 laterally protrudes, on one side thereof, beyond the counter-side film substrate 7 (counter substrate 7′), and such a protrusion serves as a terminal region 13 on which a driver chip is mounted.

A laminated film 15 is bonded to a surface of the TFT-side film substrate 5 (TFT substrate 5′) opposite to the liquid crystal layer 11 with a photo-curable transparent adhesive layer 17 being interposed therebetween. The laminated film 15 is hereinafter referred to as a “TFT-side laminated film 15,” and the photo-curable transparent adhesive layer 17 is hereinafter referred to as a “TFT-side photo-curable transparent adhesive layer 17.”

The TFT-side laminated film 15 is made of polyethylene naphthalate (PEN), polyethylene terephthalate (PET), polyether sulfone (PES), polycarbonate (PC), or cycloolefin polymer (COP). The thickness of the TFT-side laminated film 15 is preferably set at equal to or greater than 50 μm considering that reinforcement of the TFT-side film substrate 5 and the counter-side film substrate 7 is increased and flexibility of the TFT-side film substrate 5 and the counter-side film substrate 7 is not reduced.

The TFT-side photo-curable transparent adhesive layer 17 is made of an acrylate-based or epoxy-based photo-curable transparent adhesive agent, and it is preferable that the TFT-side photo-curable transparent adhesive layer 17 is made of, e.g., LCR0631, 0632. 0753. 0239 manufactured by Toagosei Co. Ltd. The thickness of the TFT-side photo-curable transparent adhesive layer 17 is preferably set at 5-20 μm. This is because it is difficult, by a current coating technique, to form the TFT-side photo-curable transparent adhesive layer 17 having a thickness of less than 5 μm, and reliability is reduced due to an increase in proportion of air bubbles in the entirety of the TFT-side photo-curable transparent adhesive layer 17. On the other hand, if the thickness exceeds 20 μm, there is a possibility that conductive particles (ACF particles) of an anisotropic conductive film (ACF) are not flattened upon connection (at 160° C. and 3 MPa for 10 sec.) of a printed wiring board (PWB) and a flexible printed circuit (EPC). This may result in connection failure. The TFT-side photo-curable transparent adhesive layer 17 preferably has an elastic modulus of 100 MPa-2 GPa at a room temperature (25° C.) after curing, and an elastic modulus of equal to or greater than 40 MPa at an environmental temperature of 60-70° C. in use. This is because the TFT-side photo-curable transparent adhesive layer 17 having an elastic modulus of less than 100 MPa is susceptible to bending, and therefore peeling or cracking occurs. The reason why the upper limit is 2 GPa is that no product having an elastic modulus of greater than 2 GPa is, at present, manufacturable in terms of flexibility, and such a product is not required.

A laminated film 19 is bonded to a surface of the counter-side film substrate 7 (counter substrate 7′) opposite to the liquid crystal layer 11 with a photo-curable transparent adhesive layer 21 being interposed therebetween. The laminated film 19 is hereinafter referred to as a “counter-side laminated film 19,” and the photo-curable transparent adhesive layer 21 is hereinafter referred to as a “counter-side photo-curable transparent adhesive layer 21.” The type and thickness of the counter-side laminated film 19 are the same as those of the TFT-side laminated film 15. The type and thickness of the counter-side photo-curable transparent adhesive layer 21 and the elastic modulus of the counter-side photo-curable transparent adhesive layer 21 after curing are the same as those of the TFT-side photo-curable transparent adhesive layer 17.

A CF 23 serving as an optical functional layer including a black matrix and a pattern of three primary colors of red, green, and blue (R, G, and B) is formed on a surface of the counter-side laminated film 19 opposite to the counter-side film substrate 7 (counter substrate 7′) by a well-known method such as photolithography or printing. The CF 23 may be formed on the counter-side laminated film 19 in advance, or may be formed after the counter-side laminated film 19 is bonded to the counter-side film substrate 7 (counter substrate 7′).

Next, a method for manufacturing the liquid crystal display 1 of the first embodiment will be described with reference to FIGS. 2(a)-2(i). A number in parentheses represents a manufacturing step.
(1) Polyimide is applied onto a glass base 25 (hereinafter referred to as a “TFT-side base 25”) to form a TFT-side film substrate 5 having a thickness of less than 50 μm. Although not shown in the figure, a plurality of gate lines extending parallel to each other and a plurality of source lines extending parallel to each other so as to be perpendicular to each of the gate lines are formed on the TFT-side film substrate 5. Then, in such a manner that a TFT is formed at each intersection between the gate and source lines and a pixel electrode is connected to the TFT, a TFT array layer is formed. An alignment film is formed on the TFT array layer. In the foregoing manner, a TFT substrate 5′ is formed (see a TFT substrate formation step illustrated in FIG. 2(a)).

Meanwhile, a common electrode is, although not shown in the figure, formed on a glass base 27 (hereinafter referred to as a “counter-side base 27”), and an alignment film is formed on the common electrode. Then, polyimide is applied to form a counter-side film substrate 7 having a thickness of less than 50 μm. In the foregoing manner, a counter substrate 7′ is formed (see a counter substrate formation step illustrated in FIG. 2(a)).

(2) For example, ultraviolet-curable epoxy-based resin is applied in a frame shape on the TFT substrate 5′. Then, the epoxy resin is cured by being irradiated with ultraviolet light in the state in which the TFT substrate 5′ and the counter substrate 7′ face each other, and the TFT substrate 5′ and the counter substrate 7′ are bonded together by a sealing material 9. Subsequently, e.g., nematic liquid crystal having electrooptical properties is injected to an internal space surrounded by the TFT substrate 5′, the counter substrate 7′, and the sealing material 9, and therefore a liquid crystal layer 11 is sealed in the internal space. In the foregoing manner, a liquid crystal panel 3 is formed (see a liquid crystal panel formation step illustrated in FIG. 2(a)). FIGS. 2(a)-2(i) illustrate the example where a plurality of liquid crystal panels 3 are formed from the TFT-side film substrate 5 and the counter-side film substrate 7 used as mother substrates.
(3) In such a manner that the resultant is irradiated with laser light B1 from a side close to the TFT-side base 25, the TFT-side base 25 is peeled from the TFT-side film substrate 5 (see a peeling step illustrated in FIG. 2(b)). The TFT-side base 25 may be mechanically peeled.
(4) An acrylate-based or epoxy-based photo-curable transparent adhesive agent is applied to a surface of the TFT-side film substrate 5 from which the TFT-side base 25 is peeled, thereby forming a TFT-side photo-curable transparent adhesive layer 17 having a thickness of 5-20 μm (see an adhesive layer formation step illustrated in FIG. 2(c)).
(5) In such a manner that a TFT-side laminated film 15 having a thickness of greater than 50 μm is pressed in vacuum atmosphere, the TFT-side laminated film 15 is bonded to the TFT-side film substrate 5 with the TFT-side photo-curable transparent adhesive layer 17 being interposed therebetween (see a film bonding step illustrated in FIG. 2(d)).
(6) The TFT-side photo-curable transparent adhesive layer 17 is cured by being irradiated with ultraviolet light (or visible light) B2 from a side close to the TFT-side laminated film 15 (see an adhesive layer curing step illustrated in FIG. 2(e)).
(7) In such a manner that the resultant is irradiated with laser light B1 from a side close to the counter-side base 27, the counter-side base 27 is peeled from the counter-side film substrate 7 (see a peeling step illustrated in FIG. 2(f)). The counter-side base 27 may be mechanically peeled.
(8) An acrylate-based or epoxy-based photo-curable transparent adhesive agent is applied to a surface of the counter-side film substrate 7 from which the counter-side base 27 is peeled, thereby forming a counter-side photo-curable transparent adhesive layer 21 having a thickness of 5-20 μm (see an adhesive layer formation step illustrated in FIG. 2(g)).
(9) In such a manner that a counter-side laminated film 19 having a thickness of greater than 50 μm is pressed in vacuum atmosphere, the counter-side laminated film 19 is bonded to the counter-side film substrate 7 with the counter-side photo-curable transparent adhesive layer 21 being interposed therebetween. Then, the counter-side photo-curable transparent adhesive layer 21 is cured by being irradiated with ultraviolet light (or visible light) B2 from a side close to the counter-side laminated film 19 (see a film bonding step and an adhesive layer curing step illustrated in FIG. 2(h)).
(10) A CF 23 serving as an optical functional layer is formed on a surface of the counter-side laminated film 19 opposite to the counter-side film substrate 7 by a well-known method such as photolithography or printing. Then, a polarizing plate is bonded to an outer part of the CF 23, and another polarizing plate is bonded to an outer part of the TFT-side laminated film 15. Moreover, a driver chip, a backlight, etc. are mounted on the polarizing plate bonded to the TFT-side laminated film 15. In the foregoing manner, a liquid crystal display 1 is formed as a finished product (see a CF formation step and a liquid crystal display formation step illustrated in FIGS. 2(h) and 2(i)).

In the liquid crystal display 1 formed as described above, the TFT-side film substrate 5 (TFT substrate 5′) is reinforced by the TFT-side laminated film 15, and the counter-side film substrate 7 (counter substrate 7′) is reinforced by the counter-side laminated film 19. Thus, no warpage of the TFT-side film substrate 5 (TFT substrate 5′) and the counter-side film substrate 7 (counter substrate 7′) due to, e.g., thermal deformation occurs, and cracking of an inorganic film, such as a gate insulating film, used for a TFT layer can be reduced or prevented. Moreover, peeling at a surface where each of the TFT-side film substrate 5 and the counter-side film substrate 7 is bonded to an adjacent layer such as the alignment film is less likely to occur. Consequently, a highly-reliable liquid crystal display 1 including a functional layer, i.e., a CF 23, at the outermost surface can be realized.

The TFT-side laminated film 15 is bonded to the TFT-side film substrate 5 with the TFT-side photo-curable transparent adhesive layer 17 being interposed therebetween, and the counter-side laminated film 19 is bonded to the counter-side film substrate 7 with the counter-side photo-curable transparent adhesive layer 21 being interposed therebetween. Thus, warpage reduction or prevention and reliability upon bending can be ensured by material properties of the photo-curable transparent adhesive agent.

Moreover, the TFT-side photo-curable transparent adhesive layer 17 and the counter-side photo-curable transparent adhesive layer 21 each has the elastic modulus of 100 MPa-2 GPa at the room temperature (25° C.) after curing, and the elastic modulus of equal to or greater than 40 MPa at the environmental temperature of 60-70° C. in use. Thus, warpage of the TFT-side film substrate 5 (TFT substrate 5′) and the counter-side film substrate 7 (counter substrate 7′) can be effectively reduced, and reliability of the TFT-side film substrate 5 (TFT substrate 5′) and the counter-side film substrate 7 (counter substrate 7′) upon bending can be improved.

Further, the TFT-side laminated film 15 is bonded to the TFT-side film substrate 5 in vacuum atmosphere, and the counter-side laminated film 19 is bonded to the counter-side film substrate 7 in vacuum atmosphere. Thus, reduction in bonding strength due to a material difference between the TFT-side laminated film 15 and the TFT-side film substrate 5 and a material difference between the counter-side laminated film 19 and the counter-side film substrate 7 can be suppressed or prevented. As a result, it can be ensured that the TFT-side laminated film 15 is bonded to the TFT-side film substrate 5, and the counter-side laminated film 19 is bonded to the counter-side film substrate 7.

### Second Embodiment

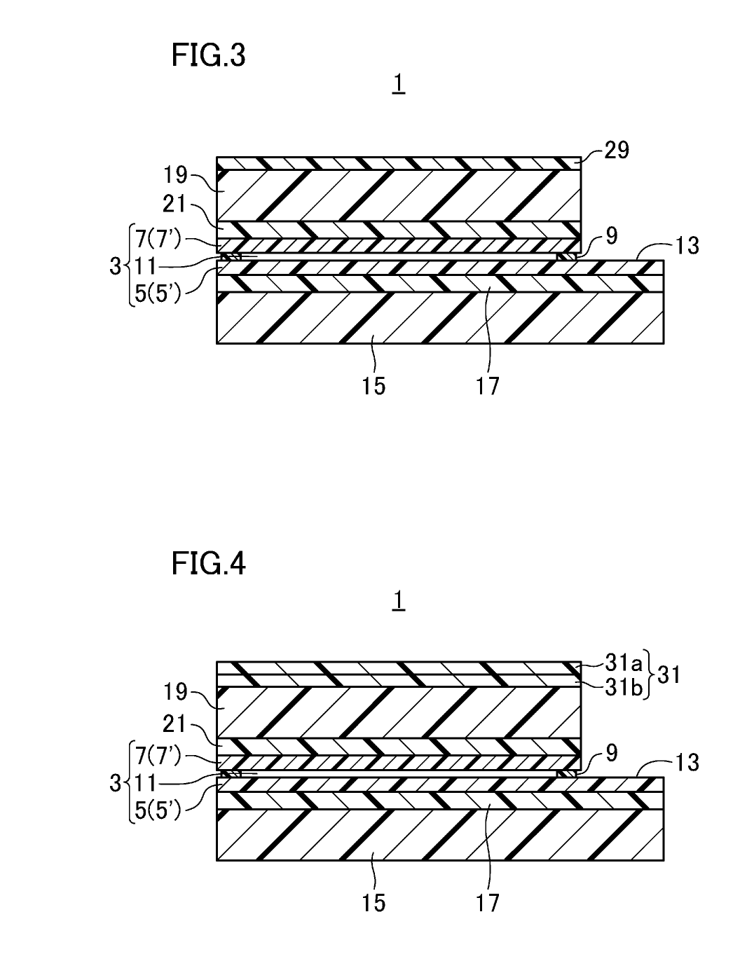

FIG. 3 illustrates a liquid crystal display 1 as a flexible display of a second embodiment.

Although not shown in the figure, a CF is formed on a counter substrate 7′ of a liquid crystal panel 3 in the second embodiment. A 3-dimensional (3D) film 29 serving as an optical function layer is bonded to a surface of a counter-side laminated film 19 opposite to a counter-side film substrate 7 with a hot-melt adhesive layer (not shown in the figure) being interposed therebetween. Since other configuration is similar to that of the first embodiment, the same reference numerals as those shown in the first embodiment are used to represent equivalent elements, and the description thereof will not be repeated.

Thus, in the second embodiment, a liquid crystal display 1 which is capable of displaying a 3-dimensional image can be realized in addition to the advantages described in the first embodiment.

### Third Embodiment

FIG. 4 illustrates a liquid crystal display 1 as a flexible display of a third embodiment.

Although not shown in the figure, a CF is, as in the second embodiment, formed on a counter substrate 7′ of a liquid crystal panel 3 in the third embodiment. A projection-type electrostatic capacitance touch panel 31 serving as a sensor functional layer is formed on a surface of a counter-side laminated film 19 opposite to the counter-side film substrate 7 by radio frequency sputtering. In FIG. 4, reference numerals “21a” and “31b” each represent an electrode. Since other configuration is similar to that of the first embodiment, the same reference numerals as those shown in the first embodiment are used to represent equivalent elements, and the description thereof will not be repeated.

Thus, in the third embodiment, a liquid crystal display 1 having a touch panel function can be realized in addition to the advantages described in the first embodiment.

### Fourth Embodiment

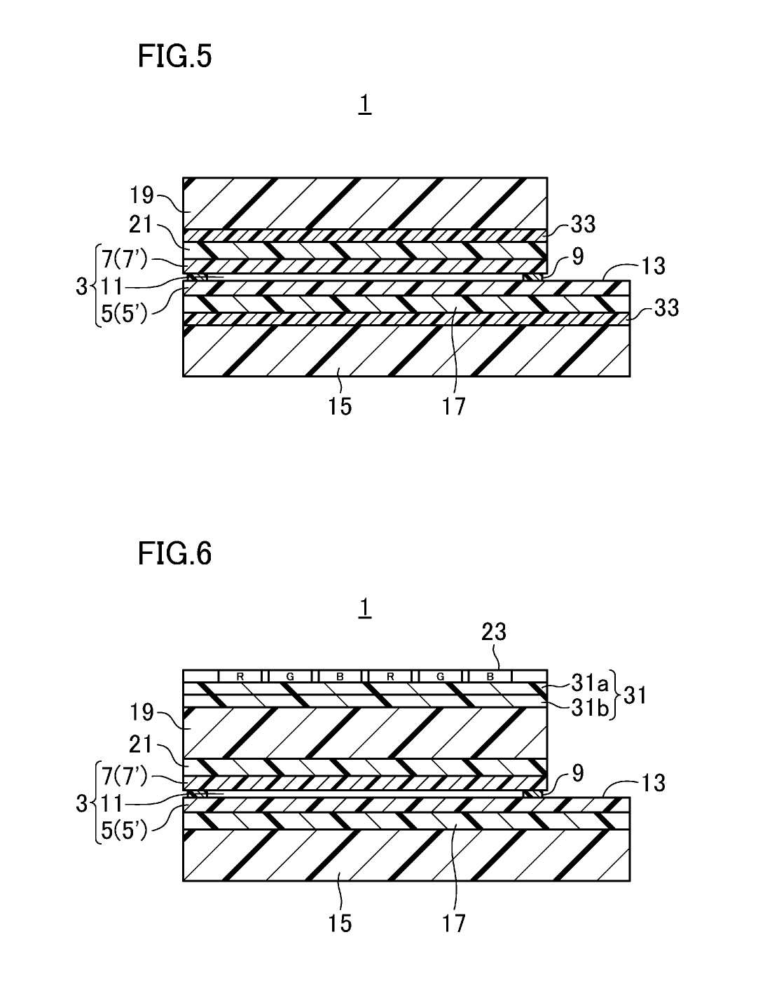

FIG. 5 illustrates a liquid crystal display 1 as a flexible display of a fourth embodiment.

Although not shown in the figure, a CF is, as in the second embodiment, formed on a counter substrate 7′ of a liquid crystal panel 3 in the fourth embodiment. A gas barrier functional layer 33 is interposed between a TFT-side photo-curable transparent adhesive layer 17 and a TFT-side laminated film 15, and another gas barrier functional layer 33 is interposed between a counter-side photo-curable transparent adhesive layer 21 and a counter-side laminated film 19. The gas barrier functional layers 33 are formed respectively on the TFT-side laminated film 15 and the counter-side laminated film 19 by radio frequency sputtering. The gas barrier functional layer 33 has barrier properties against water and oxygen gas. Examples of the gas barrier functional layer 33 include an inorganic film made of a silicon oxide-based, silicon oxynitride-based, alumina oxide-based, or titanium oxide-based material, or a multilayer film of the inorganic film and an organic film made of a polyvinyl alcohol-based, polyvinylidene chloride-based, acrylonitrile-based, acrylic acid-based, or nylon-based material. Since other configuration is similar to that of the first embodiment, the same reference numerals as those shown in the first embodiment are used to represent equivalent elements, and the description thereof will not be repeated.

Thus, in the fourth embodiment, a liquid crystal display 1 in which the liquid crystal panel 3 can be protected by the gas barrier properties can be realized in addition to the advantages described in the first embodiment.

### Fifth Embodiment

FIG. 6 illustrates a liquid crystal display 1 as a flexible display of a fifth embodiment.

For the fifth embodiment, the first and third embodiments are combined together. That is, a projection-type electrostatic capacitance touch panel 31 serving as a sensor functional layer is formed on a surface of a counter-side laminated film 19 opposite to a counter-side film substrate 7, and a CF 23 serving as an optical functional layer is formed on the touch panel 31. Since other configuration is similar to that of the first embodiment, the same reference numerals as those shown in the first embodiment are used to represent equivalent elements, and the description thereof will not be repeated.

Thus, in the fifth embodiment, a liquid crystal display 1 having the touch panel function of the third embodiment can be realized in addition to the advantages of the first embodiment.

### Sixth Embodiment

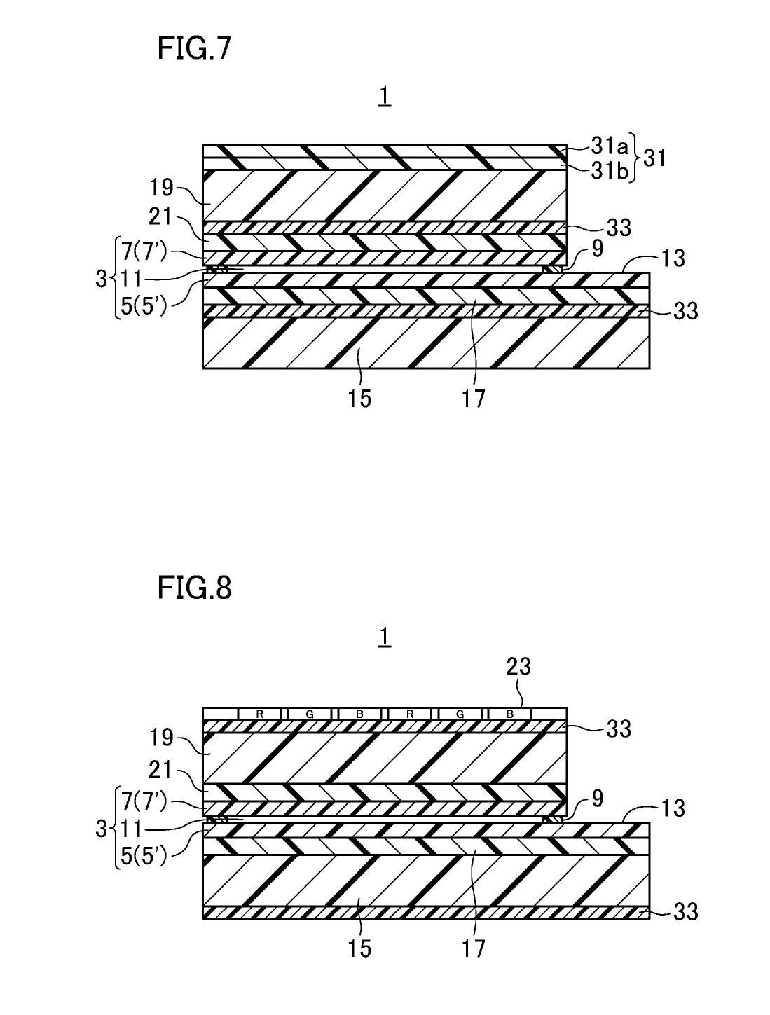

FIG. 7 illustrates a liquid crystal display 1 as a flexible display of a sixth embodiment.

For the sixth embodiment, the third and fourth embodiments are combined together. That is, a gas barrier functional layer 33 is interposed between a TFT-side photo-curable transparent adhesive layer 17 and a TFT-side laminated film 15, and another gas barrier functional layer 33 is interposed between a counter-side photo-curable transparent adhesive layer 21 and a counter-side laminated film 19. Moreover, a projection-type electrostatic capacitance touch panel 31 serving as a sensor functional layer is formed on a surface of the counter-side laminated film 19 opposite to a counter-side film substrate 7. Since other configuration is similar to that of the first embodiment, the same reference numerals as those shown in the first embodiment are used to represent equivalent elements, and the description thereof will not be repeated.

Thus, in the sixth embodiment, a liquid crystal display 1 having the touch panel function of the third embodiment and the gas bather function of the fourth embodiment can be realized in addition to the advantages of the first embodiment.

### Seventh Embodiment

FIG. 8 illustrates a liquid crystal display 1 as a flexible display of a seventh embodiment.

In the seventh embodiment, two gas barrier functional layers 33 are formed in the configuration of the first embodiment. That is, in the first embodiment, a gas barrier functional layer 33 is formed between a counter-side laminated film 19 and a CF 23, and another gas barrier functional layer 33 is formed on a surface of a TFT-side laminated film 15 opposite to a TFT substrate 5′. Since other configuration is similar to that of the first embodiment, the same reference numerals as those shown in the first embodiment are used to represent equivalent elements, and the description thereof will not be repeated.

Thus, in the seventh embodiment, a liquid crystal display 1 having a gas barrier function can be realized in addition to the advantages of the first embodiment.

### Eighth Embodiment

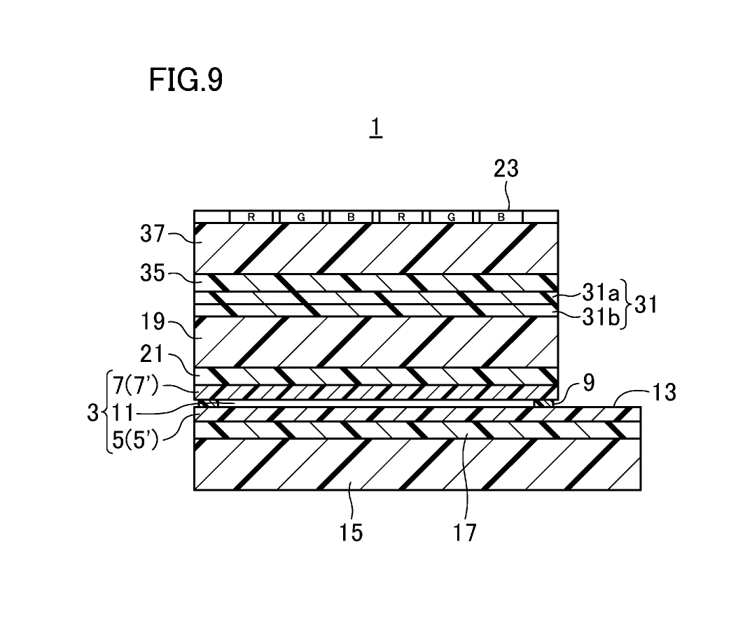

FIG. 9 illustrates a liquid crystal display 1 as a flexible display of an eighth embodiment.

In the eighth embodiment, a projection-type electrostatic capacitance touch panel 31 serving as a sensor functional layer is formed in the configuration of the first embodiment. That is, in the first embodiment, a touch panel 31 is formed on a surface of a counter-side laminated film 19 opposite to a counter substrate 7′, and a laminated film 37 is bonded to the touch panel 31 with a photo-curable transparent adhesive layer 35 being interposed therebetween. Then, a CF 23 is formed on the laminated film 37. Since other configuration is similar to that of the first embodiment, the same reference numerals as those shown in the first embodiment are used to represent equivalent elements, and the description thereof will not be repeated.

Thus, in the eighth embodiment, a liquid crystal display 1 including a sensor functional layer can be realized in addition to the advantages of the first embodiment.

In each of the foregoing embodiments, the CF 23 has been described as an example of the optical functional layer. However, an anti-reflection (AR) film, an anti-glare (AG) film, a retardation film, or a polarizing film can be employed. Moreover, the projection-type electrostatic capacitance touch panel 31 has been described as an example of the sensor functional layer. However, a surface-type electrostatic capacitance touch panel or a pressure-sensitive touch panel may be employed. Further, any combination of the optical functional layer, the sensor functional layer, and the gas barrier layer may be applied.

The method for manufacturing the liquid crystal display 1 as described in the first embodiment has been described as an example. A functional layer formation step may be performed before or after the film bonding step. Moreover, the adhesive layer curing step may be performed in parallel with the film bonding step, or may be performed after the film bonding step and the functional layer formation step.

In each of the foregoing embodiments, the liquid crystal display 1 in which the light emitting device is the liquid crystal device has been described as an example of the flexible display. However, the present disclosure is applicable to an organic electro luminescence (EL) display in which a light emitting device is an organic EL device, or an electrophoretic display in which a light emitting device is an electrophoretic device.

### INDUSTRIAL APPLICABILITY

The present disclosure is useful as a high-quality thin flexible display, such as a liquid crystal display, in which a plurality of functional layers can be formed, and as a method for manufacturing the flexible display.

### DESCRIPTION OF REFERENCE CHARACTERS

1 Liquid Crystal Display (Flexible Display)
3 Liquid Crystal Panel (Display Panel)
5 TFT-Side Film Substrate (Flexible Film Substrate)
7 Counter-Side Film Substrate (Flexible Film Substrate)
15 TFT-Side Laminated Film
17 TFT-Side Photo-Curable Transparent Adhesive Layer
19 Counter-Side Laminated Film
21 Counter-Side Photo-Curable Transparent Adhesive Layer
23 CF (Optical Functional Layer)
29 3D film (Optical Functional Layer)
31 Touch Panel (Sensor Functional Layer)
33 Gas Barrier Functional Layer

1. A flexible display, comprising:
a display panel including a flexible film substrate made of resin and a light emitting device; and
a laminated film bonded to the flexible film substrate of the display panel with a photo-curable transparent adhesive layer being interposed therebetween,
wherein one or more of an optical functional layer, a sensor functional layer, and a gas barrier functional layer is formed on a surface of the laminated film on at least one of a side close to the flexible film substrate or a side opposite to the flexible film substrate.

2. The flexible display of claim 1, wherein
the flexible film substrate is made of polyimide.

3. The flexible display of claim 1, wherein
the laminated film is made of polyethylene naphthalate, polyethylene terephthalate, polyether sulfone, polycarbonate, or cycloolefin polymer.

4. The flexible display of claim 1, wherein
the photo-curable transparent adhesive layer is made of an acrylate-based or epoxy-based photo-curable transparent adhesive agent.

5. The flexible display of claim 4, wherein
the photo-curable transparent adhesive layer has an elastic modulus of 100 MPa-2 GPa at a room temperature of 25° C. after curing, and has an elastic modulus of equal to or greater than 40 MPa at an environmental temperature of 60-70° C. in use.

6. The flexible display of claim 1, wherein
the optical functional layer is formed of a color filter (CF), an anti-reflection (AR) film, an anti-glare (AG) film, a retardation film, a polarizing film, or a 3-dimensional (3D) film.

7. The flexible display of claim 1, wherein
the sensor functional layer is formed of an electrostatic capacitance touch panel or a pressure-sensitive touch panel.

8. The flexible display of claim 1, wherein
the gas barrier functional layer is formed of an inorganic film made of a silicon oxide-based, silicon oxynitride-based, alumina oxide-based, or titanium oxide-based material, or a multilayer film of the inorganic film and an organic film made of a polyvinyl alcohol-based, polyvinylidene chloride-based, acrylonitrile-based, acrylic acid-based, or nylon-based material.

9. The flexible display of claim 1, wherein
the light emitting device is a liquid crystal device, an organic electro luminescence (EL) device, or an electrophoretic device.

10. A method for manufacturing a flexible display, comprising:
an adhesive layer formation step of forming, for a display panel including a flexible film substrate made of resin and a light emitting device, a photo-curable transparent adhesive layer on the flexible film substrate of the display panel;
a film bonding step of bonding, after the adhesive layer formation step, a laminated film to the flexible film substrate in vacuum atmosphere with the photo-curable transparent adhesive layer being interposed therebetween;
a functional layer formation step of forming, before or after the film bonding step, one or more of an optical functional layer, a sensor functional layer, and a gas barrier functional layer on a surface of the laminated film on at least one of a side close to the flexible film substrate or a side opposite to the flexible film substrate; and
an adhesive layer curing step of curing, in parallel with the film bonding step or after the film bonding step and the functional layer formation step, the photo-curable transparent adhesive layer by light irradiation.
